(19) United States
(12) Patent Application Publication
(10) Pub. No.: US 2026/0160536 A1
(43) Pub. Date: Jun. 11, 2026

(54) RETAIL SIZING SYSTEM FOR WEARABLE RING DEVICES

(71) Applicant: Oura Health Oy, Oulu (FI)

(72) Inventor: Jefferson Ian Morris, Dellwood, MN (US)

(21) Appl. No.: 19/179,522

(22) Filed: Apr. 15, 2025

Related U.S. Application Data
(60) Provisional application No. 63/639,349, filed on Apr. 26, 2024.

(51) Int. Cl. G01B 3/34

(52) U.S. Cl. CPC G01B 3/34

(57) ABSTRACT

Methods, systems, and devices for a ring sizing system for wearable ring devices are described. A retail sizing system may include a set of ring sizing devices corresponding to a set of ring sizes and configured to transition between an open configuration and a closed configuration. Each respective ring sizing device may include one or more magnets and a locking assembly that is configured to maintain the respective ring sizing device in the closed configuration when a force exerted on the respective ring sizing device is less than a threshold, and transition the respective ring sizing device to the open configuration when the force exceeds the threshold. The retail sizing system may further include a set of sizing ports configured to receive the respective ring sizing devices, magnets, and a set of retractable cable mechanisms that retain each of the ring sizing devices in a defined position/orientation on/within the base.

### CROSS REFERENCE

The present Application for Patent claims the benefit of U.S. Provisional Ser. No. 63/639,349 by MORRIS, entitled “RETAIL SIZING SYSTEM FOR WEARABLE DEVICES,” filed Apr. 26, 2024, assigned to the assignee hereof, and expressly incorporated by reference herein.

### FIELD OF TECHNOLOGY

The following relates to wearable devices and data processing, including a retail sizing system for wearable ring devices.

### BACKGROUND

Some wearable devices may be configured to collect physiological data from users, where a level or quality of skin contact between the wearable device and the user's tissue may affect the quality of physiological data measurements. As such, proper fit of a wearable device may be critical for accurate data collection. Thus, for wearable devices of fixed sizes, users may use sizing kits to determine which size of the wearable device fits them properly (e.g., to support accurate data collection), where the sizing kits include multiple sizing models of the wearable device in varying sizes. However, in some cases, a user may try on a sizing model of the wearable device that is too small for them, such that the sizing model becomes stuck and may need to be broken or damaged to be removed from the user, risking harm to the user. Further, in cases where sizing kits are implemented in a retail establishment, there is a need for a system to efficiently present the ring sizing devices in a visually appealing and an easy-to-find manner, and to prevent the ring sizing devices from being lost or stolen.

### BRIEF DESCRIPTION OF THE DRAWINGS

FIG. 1 illustrates an example of a system that supports a retail sizing system for wearable ring devices in accordance with aspects of the present disclosure.

FIG. 2 illustrates an example of a system that supports a retail sizing system for wearable ring devices in accordance with aspects of the present disclosure.

FIGS. 3A and 3B show examples of a retail sizing assembly of a retail sizing system for wearable ring devices in accordance with aspects of the present disclosure.

FIG. 4 shows an example of a ring sizing device of a retail sizing system for wearable ring devices in accordance with aspects of the present disclosure.

### DETAILED DESCRIPTION

Wearable devices may be configured to collect physiological data from users, such as light-based photoplethysmogram (PPG) data. However, the level or quality of skin contact between the wearable device and the user's tissue may affect the quality of PPG measurements. In particular, varying pressure between the wearable device and the user's tissue may affect how light is transmitted into, through, and out of the user's tissue, thereby affecting PPG measurements. As such, ill-fitting wearable devices that do not achieve relatively constant skin contact may result in poor PPG data. Thus, ensuring proper fit of a wearable device on a user may be critical for accurate data collection.

In many cases, wearable devices, such as wearable ring devices, may come in fixed sizes, where users may use a sizing kit to determine which size of the wearable ring device fits them properly (e.g., ensures constant skin contact). For example, a sizing kit may include multiple “sizing rings” (e.g., or models of wearable ring devices) of varying size, such that the user may place each sizing ring on their finger to determine which size of wearable ring device fits them properly. However, in some cases, the user may place a sizing ring on their finger that is too small, such that the sizing ring becomes stuck on their finger. In such cases, the sizing ring may need to be broken or damaged to remove the ring from the user's finger, which may risk damage to the user's finger. Further, in cases where sizing kits are implemented in a retail establishment, there is a need for a system to efficiently present the ring sizing devices in a visually appealing and an easy-to-find manner, and to prevent the ring sizing devices from being lost or stolen.

Accordingly, aspects of the present disclosure are directed to a retail sizing assembly (e.g., retail sizing kit) for wearable ring devices. In some aspects, the retail sizing assembly may include multiple ring sizing devices that are attached to a body of the retail sizing assembly via magnets and/or retractable cable mechanisms. The retractable cable mechanisms may connect the ring sizing devices to the body, and allow for limited movement of the ring sizing devices relative to the body to enable users to try on the ring sizing devices, and to prevent the ring sizing devices from becoming misplaced or stolen. In some aspects, the magnets within the body may engage with magnets within the respective ring sizing devices to maintain the ring sizing devices in a defined orientation on/within the body (e.g., keep all ring sizing devices facing the same direction).

In some aspects, the ring sizing devices (e.g., sizing rings) may enable the user to safely remove their finger from the ring sizing device in the case that the user's finger becomes stuck. In particular, aspects of the present disclosure are directed to “hinged” ring sizing devices that include two ring housing components that are coupled to one another via a hinge to enable the first ring sizing device to transition between an “open configuration” and a “closed configuration.” The two housing components of a respective ring sizing device may mimic a wearable ring device form factor when in the closed configuration.

The ends of the housing components opposite from the hinge may be coupled to one another via a locking mechanism, where the locking mechanism may include mechanical components, magnetic components, or both. For example, the locking mechanism may include a first mechanical/magnetic component on the first housing component that engages a second mechanical/magnetic component on the second housing component. The locking mechanism may be configured to retain the first ring sizing device in the closed configuration (for accurate ring sizing) until a threshold force (e.g., sufficiently large force) is exerted on the first ring sizing device, at which point the locking mechanism may disengage and enable the first ring sizing device to transition to the open configuration. In this regard, the locking mechanism may retain the first ring sizing device in the closed configuration as the user tries on the ring sizing device (for accurate ring sizing). However, if the user's finger becomes stuck in the first ring sizing device, the user may exert a force to disengage the locking mechanism to pull apart the housing components (e.g., transition the first ring sizing device to the open configuration) to enable the user to safely remove their finger.

Aspects of the disclosure are initially described in the context of systems supporting physiological data collection from users via wearable devices. Additional aspects of the disclosure are described in the context of an example retail sizing assembly and an example ring sizing device. Aspects of the disclosure are further illustrated by and described with reference to apparatus diagrams, system diagrams, and flowcharts that relate to a retail sizing system for wearable ring devices.

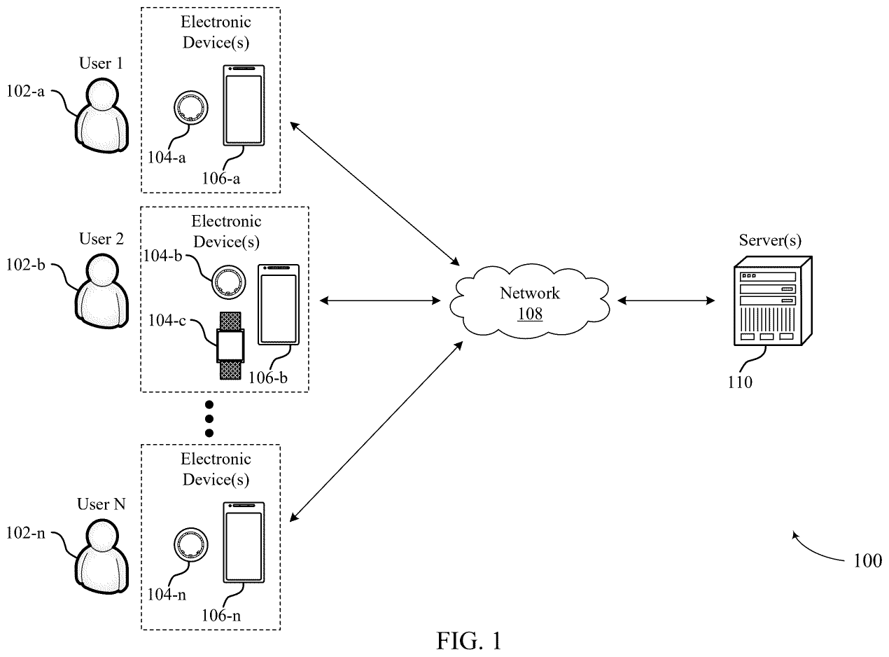

FIG. 1 illustrates an example of a system 100 that supports a retail sizing system for wearable ring devices in accordance with aspects of the present disclosure. The system 100 includes a plurality of electronic devices (e.g., wearable devices 104, user devices 106) that may be worn and/or operated by one or more users 102. The system 100 further includes a network 108 and one or more servers 110.

The electronic devices may include any electronic devices known in the art, including wearable devices 104 (e.g., wearable ring devices, watch wearable devices, etc.), user devices 106 (e.g., smartphones, laptops, tablets). The electronic devices associated with the respective users 102 may include one or more of the following functionalities: 1) measuring physiological data, 2) storing the measured data, 3) processing the data, 4) providing outputs (e.g., via GUIs) to a user 102 based on the processed data, and 5) communicating data with one another and/or other computing devices. Different electronic devices may perform one or more of the functionalities.

Example wearable devices 104 may include wearable computing devices, such as a ring computing device (hereinafter “ring”) configured to be worn on a user's 102 finger, a wrist computing device (e.g., a smart watch, fitness band, or bracelet) configured to be worn on a user's 102 wrist, and/or a head mounted computing device (e.g., glasses/goggles). Wearable devices 104 may also include bands, straps (e.g., flexible or inflexible bands or straps), stick-on sensors, and the like, that may be positioned in other locations, such as bands around the head (e.g., a forehead headband), arm (e.g., a forearm band and/or bicep band), and/or leg (e.g., a thigh or calf band), behind the ear, under the armpit, and the like. Wearable devices 104 may also be attached to, or included in, articles of clothing. For example, wearable devices 104 may be included in pockets and/or pouches on clothing. As another example, wearable device 104 may be clipped and/or pinned to clothing, or may otherwise be maintained within the vicinity of the user 102. Example articles of clothing may include, but are not limited to, hats, shirts, gloves, pants, socks, outerwear (e.g., jackets), and undergarments. In some implementations, wearable devices 104 may be included with other types of devices such as training/sporting devices that are used during physical activity. For example, wearable devices 104 may be attached to, or included in, a bicycle, skis, a tennis racket, a golf club, and/or training weights.

Much of the present disclosure may be described in the context of a wearable ring device 104. Accordingly, the terms “ring 104,” “wearable device 104,” and like terms, may be used interchangeably, unless noted otherwise herein. However, the use of the term “ring 104” is not to be regarded as limiting, as it is contemplated herein that aspects of the present disclosure may be performed using other wearable devices (e.g., watch wearable devices, necklace wearable device, bracelet wearable devices, earring wearable devices, anklet wearable devices, and the like).

In some aspects, user devices 106 may include handheld mobile computing devices, such as smartphones and tablet computing devices. User devices 106 may also include personal computers, such as laptop and desktop computing devices. Other example user devices 106 may include server computing devices that may communicate with other electronic devices (e.g., via the Internet). In some implementations, computing devices may include medical devices, such as external wearable computing devices (e.g., Holter monitors). Medical devices may also include implantable medical devices, such as pacemakers and cardioverter defibrillators. Other example user devices 106 may include home computing devices, such as internet of things (IoT) devices (e.g., IoT devices), smart televisions, smart speakers, smart displays (e.g., video call displays), hubs (e.g., wireless communication hubs), security systems, smart appliances (e.g., thermostats and refrigerators), and fitness equipment.

Some electronic devices (e.g., wearable devices 104, user devices 106) may measure physiological parameters of respective users 102, such as photoplethysmography waveforms, continuous skin temperature, a pulse waveform, respiration rate, heart rate, heart rate variability (HRV), actigraphy, galvanic skin response, pulse oximetry, blood oxygen saturation (SpO2), blood sugar levels (e.g., glucose metrics), and/or other physiological parameters. Some electronic devices that measure physiological parameters may also perform some/all of the calculations described herein. Some electronic devices may not measure physiological parameters, but may perform some/all of the calculations described herein. For example, a ring (e.g., wearable device 104), mobile device application, or a server computing device may process received physiological data that was measured by other devices.

In some implementations, a user 102 may operate, or may be associated with, multiple electronic devices, some of which may measure physiological parameters and some of which may process the measured physiological parameters. In some implementations, a user 102 may have a ring (e.g., wearable device 104) that measures physiological parameters. The user 102 may also have, or be associated with, a user device 106 (e.g., mobile device, smartphone), where the wearable device 104 and the user device 106 are communicatively coupled to one another. In some cases, the user device 106 may receive data from the wearable device 104 and perform some/all of the calculations described herein. In some implementations, the user device 106 may also measure physiological parameters described herein, such as motion/activity parameters.

For example, as illustrated in FIG. 1, a first user 102-a (User 1) may operate, or may be associated with, a wearable device 104-a (e.g., ring 104-a) and a user device 106-a that may operate as described herein. In this example, the user device 106-a associated with user 102-a may process/store physiological parameters measured by the ring 104-a. Comparatively, a second user 102-b (User 2) may be associated with a ring 104-b, a watch wearable device 104-c (e.g., watch 104-c), and a user device 106-b, where the user device 106-b associated with user 102-b may process/store physiological parameters measured by the ring 104-b and/or the watch 104-c. Moreover, an nth user 102-n (User N) may be associated with an arrangement of electronic devices described herein (e.g., ring 104-n, user device 106-n). In some aspects, wearable devices 104 (e.g., rings 104, watches 104) and other electronic devices may be communicatively coupled to the user devices 106 of the respective users 102 via Bluetooth, Wi-Fi, and other wireless protocols. Moreover, in some cases, the wearable device 104 and the user device 106 may be included within (or make up) the same device. For example, in some cases, the wearable device 104 may be configured to execute an application associated with the wearable device 104, and may be configured to display data via a GUI.

In some implementations, the rings 104 (e.g., wearable devices 104) of the system 100 may be configured to collect physiological data from the respective users 102 based on arterial blood flow within the user's finger. In particular, a ring 104 may utilize one or more light-emitting components, such as LEDs (e.g., red LEDs, green LEDs) that emit light on the palm-side of a user's finger to collect physiological data based on arterial blood flow within the user's finger. In general, the terms light-emitting components, light-emitting elements, and like terms, may include, but are not limited to, LEDs, micro LEDs, mini LEDs, laser diodes (LDs) (e.g., vertical cavity surface-emitting lasers (VCSELs), and the like.

In some cases, the system 100 may be configured to collect physiological data from the respective users 102 based on blood flow diffused into a microvascular bed of skin with capillaries and arterioles. For example, the system 100 may collect PPG data based on a measured amount of blood diffused into the microvascular system of capillaries and arterioles. In some implementations, the ring 104 may acquire the physiological data using a combination of both green and red LEDs. The physiological data may include any physiological data known in the art including, but not limited to, temperature data, accelerometer data (e.g., movement/motion data), heart rate data, HRV data, blood oxygen level data, or any combination thereof.

The use of both green and red LEDs may provide several advantages over other solutions, as red and green LEDs have been found to have their own distinct advantages when acquiring physiological data under different conditions (e.g., light/dark, active/inactive) and via different parts of the body, and the like. For example, green LEDs have been found to exhibit better performance during exercise. Moreover, using multiple LEDs (e.g., green and red LEDs) distributed around the ring 104 has been found to exhibit superior performance as compared to wearable devices that utilize LEDs that are positioned close to one another, such as within a watch wearable device. Furthermore, the blood vessels in the finger (e.g., arteries, capillaries) are more accessible via LEDs as compared to blood vessels in the wrist. In particular, arteries in the wrist are positioned on the bottom of the wrist (e.g., palm-side of the wrist), meaning only capillaries are accessible on the top of the wrist (e.g., back of hand side of the wrist), where wearable watch devices and similar devices are typically worn. As such, utilizing LEDs and other sensors within a ring 104 has been found to exhibit superior performance as compared to wearable devices worn on the wrist, as the ring 104 may have greater access to arteries (as compared to capillaries), thereby resulting in stronger signals and more valuable physiological data.

The electronic devices of the system 100 (e.g., user devices 106, wearable devices 104) may be communicatively coupled to one or more servers 110 via wired or wireless communication protocols. For example, as shown in FIG. 1, the electronic devices (e.g., user devices 106) may be communicatively coupled to one or more servers 110 via a network 108. The network 108 may implement transfer control protocol and internet protocol (TCP/IP), such as the Internet, or may implement other network 108 protocols. Network connections between the network 108 and the respective electronic devices may facilitate transport of data via email, web, text messages, mail, or any other appropriate form of interaction within a computer network 108. For example, in some implementations, the ring 104-a associated with the first user 102-a may be communicatively coupled to the user device 106-a, where the user device 106-a is communicatively coupled to the servers 110 via the network 108. In additional or alternative cases, wearable devices 104 (e.g., rings 104, watches 104) may be directly communicatively coupled to the network 108.

The system 100 may offer an on-demand database service between the user devices 106 and the one or more servers 110. In some cases, the servers 110 may receive data from the user devices 106 via the network 108, and may store and analyze the data. Similarly, the servers 110 may provide data to the user devices 106 via the network 108. In some cases, the servers 110 may be located at one or more data centers. The servers 110 may be used for data storage, management, and processing. In some implementations, the servers 110 may provide a web-based interface to the user device 106 via web browsers.

In some aspects, the system 100 may detect periods of time that a user 102 is asleep, and classify periods of time that the user 102 is asleep into one or more sleep stages (e.g., sleep stage classification). For example, as shown in FIG. 1, User 102-a may be associated with a wearable device 104-a (e.g., ring 104-a) and a user device 106-a. In this example, the ring 104-a may collect physiological data associated with the user 102-a, including temperature, heart rate, HRV, respiratory rate, and the like. In some aspects, data collected by the ring 104-a may be input to a machine learning classifier, where the machine learning classifier is configured to determine periods of time that the user 102-a is (or was) asleep. Moreover, the machine learning classifier may be configured to classify periods of time into different sleep stages, including an awake sleep stage, a rapid eye movement (REM) sleep stage, a light sleep stage (non-REM (NREM)), and a deep sleep stage (NREM). In some aspects, the classified sleep stages may be displayed to the user 102-a via a GUI of the user device 106-a. Sleep stage classification may be used to provide feedback to a user 102-a regarding the user's sleeping patterns, such as recommended bedtimes, recommended wake-up times, and the like. Moreover, in some implementations, sleep stage classification techniques described herein may be used to calculate scores for the respective user, such as Sleep Scores, Readiness Scores, and the like.

In some aspects, the system 100 may utilize circadian rhythm-derived features to further improve physiological data collection, data processing procedures, and other techniques described herein. The term circadian rhythm may refer to a natural, internal process that regulates an individual's sleep-wake cycle, that repeats approximately every 24 hours. In this regard, techniques described herein may utilize circadian rhythm adjustment models to improve physiological data collection, analysis, and data processing. For example, a circadian rhythm adjustment model may be input into a machine learning classifier along with physiological data collected from the user 102-a via the wearable device 104-a. In this example, the circadian rhythm adjustment model may be configured to “weight,” or adjust, physiological data collected throughout a user's natural, approximately 24-hour circadian rhythm. In some implementations, the system may initially start with a “baseline” circadian rhythm adjustment model, and may modify the baseline model using physiological data collected from each user 102 to generate tailored, individualized circadian rhythm adjustment models that are specific to each respective user 102.

In some aspects, the system 100 may utilize other biological rhythms to further improve physiological data collection, analysis, and processing by phase of these other rhythms. For example, if a weekly rhythm is detected within an individual's baseline data, then the model may be configured to adjust “weights” of data by day of the week. Biological rhythms that may require adjustment to the model by this method include: 1) ultradian (faster than a day rhythms, including sleep cycles in a sleep state, and oscillations from less than an hour to several hours periodicity in the measured physiological variables during wake state; 2) circadian rhythms; 3) non-endogenous daily rhythms shown to be imposed on top of circadian rhythms, as in work schedules; 4) weekly rhythms, or other artificial time periodicities exogenously imposed (e.g., in a hypothetical culture with 12 day “weeks,” 12 day rhythms could be used); 5) multi-day ovarian rhythms in women and spermatogenesis rhythms in men; 6) lunar rhythms (relevant for individuals living with low or no artificial lights); and 7) seasonal rhythms.

The biological rhythms are not always stationary rhythms. For example, many women experience variability in ovarian cycle length across cycles, and ultradian rhythms are not expected to occur at exactly the same time or periodicity across days even within a user. As such, signal processing techniques sufficient to quantify the frequency composition while preserving temporal resolution of these rhythms in physiological data may be used to improve detection of these rhythms, to assign phase of each rhythm to each moment in time measured, and to thereby modify adjustment models and comparisons of time intervals. The biological rhythm-adjustment models and parameters can be added in linear or non-linear combinations as appropriate to more accurately capture the dynamic physiological baselines of an individual or group of individuals.

In some aspects, the devices of the system 100, such as rings 104, may come in fixed sizes, where users 102 may use a sizing kit (e.g., retail sizing assembly) that includes multiple ring sizing devices corresponding to multiple ring sizes. That is, the system 100 may include or may otherwise support a sizing kit/retail sizing assembly that users can utilize to determine the size of wearable ring device 104 that accurately fit their finger(s).

In some aspects, the retail sizing assembly may include multiple ring sizing devices that are attached to a body of the retail sizing assembly via magnets and/or retractable cable mechanisms. The retractable cable mechanisms may connect the ring sizing devices to the body, and allow for limited movement of the ring sizing devices relative to the body to enable users to try on the ring sizing devices, and to prevent the ring sizing devices from becoming misplaced or stolen. In some aspects, the magnets within the body may engage with magnets within the respective ring sizing devices to maintain the ring sizing devices in a defined orientation on/within the body (e.g., keep all ring sizing devices facing the same direction).

In some aspects, the ring sizing devices (e.g., sizing rings) may enable the user to safely remove their finger from the ring sizing device in the case that the user's finger becomes stuck. In particular, aspects of the present disclosure are directed to “hinged” ring sizing devices that include two ring housing components that are coupled to one another via a hinge to enable the first ring sizing device to transition between an “open configuration” and a “closed configuration.” The two housing components of a respective ring sizing device may mimic a wearable ring device form factor when in the closed configuration.

It should be appreciated by a person skilled in the art that one or more aspects of the disclosure may be implemented in a system 100 to additionally, or alternatively, solve other problems than those described herein. Furthermore, aspects of the disclosure may provide technical improvements to “conventional” systems or processes as described herein. However, the description and appended drawings only include example technical improvements resulting from implementing aspects of the disclosure, and accordingly do not represent all of the technical improvements provided within the scope of the claims.

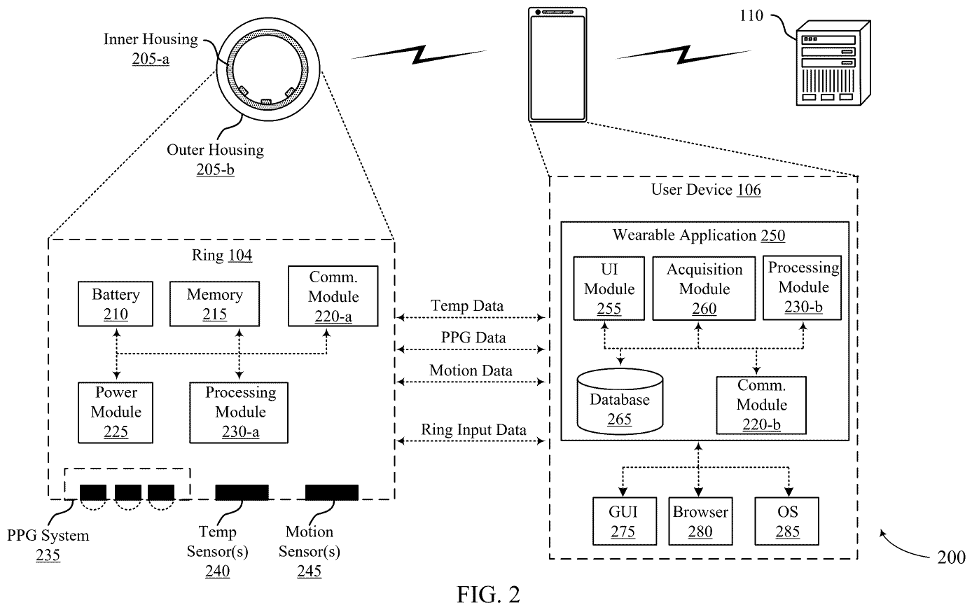

FIG. 2 illustrates an example of a system 200 that supports a retail sizing system for wearable ring devices in accordance with aspects of the present disclosure. The system 200 may implement, or be implemented by, system 100. In particular, system 200 illustrates an example of a ring 104 (e.g., wearable device 104), a user device 106, and a server 110, as described with reference to FIG. 1.

In some aspects, the ring 104 may be configured to be worn around a user's finger, and may determine one or more user physiological parameters when worn around the user's finger. Example measurements and determinations may include, but are not limited to, user skin temperature, pulse waveforms, respiratory rate, heart rate, HRV, blood oxygen levels (SpO2), blood sugar levels (e.g., glucose metrics), and the like.

The system 200 further includes a user device 106 (e.g., a smartphone) in communication with the ring 104. For example, the ring 104 may be in wireless and/or wired communication with the user device 106. In some implementations, the ring 104 may send measured and processed data (e.g., temperature data, photoplethysmogram (PPG) data, motion/accelerometer data, ring input data, and the like) to the user device 106. The user device 106 may also send data to the ring 104, such as ring 104 firmware/configuration updates. The user device 106 may process data. In some implementations, the user device 106 may transmit data to the server 110 for processing and/or storage.

The ring 104 may include a housing 205 that may include an inner housing 205-a and an outer housing 205-b. In some aspects, the housing 205 of the ring 104 may store or otherwise include various components of the ring including, but not limited to, device electronics, a power source (e.g., battery 210, and/or capacitor), one or more substrates (e.g., printable circuit boards) that interconnect the device electronics and/or power source, and the like. The device electronics may include device modules (e.g., hardware/software), such as: a processing module 230-a, a memory 215, a communication module 220-a, a power module 225, and the like. The device electronics may also include one or more sensors. Example sensors may include one or more temperature sensors 240, a PPG sensor assembly (e.g., PPG system 235), and one or more motion sensors 245.

The sensors may include associated modules (not illustrated) configured to communicate with the respective components/modules of the ring 104, and generate signals associated with the respective sensors. In some aspects, each of the components/modules of the ring 104 may be communicatively coupled to one another via wired or wireless connections. Moreover, the ring 104 may include additional and/or alternative sensors or other components that are configured to collect physiological data from the user, including light sensors (e.g., LEDs), oximeters, and the like.

The ring 104 shown and described with reference to FIG. 2 is provided solely for illustrative purposes. As such, the ring 104 may include additional or alternative components as those illustrated in FIG. 2. Other rings 104 that provide functionality described herein may be fabricated. For example, rings 104 with fewer components (e.g., sensors) may be fabricated. In a specific example, a ring 104 with a single temperature sensor 240 (or other sensor), a power source, and device electronics configured to read the single temperature sensor 240 (or other sensor) may be fabricated. In another specific example, a temperature sensor 240 (or other sensor) may be attached to a user's finger (e.g., using adhesives, wraps, clamps, spring loaded clamps, etc.). In this case, the sensor may be wired to another computing device, such as a wrist worn computing device that reads the temperature sensor 240 (or other sensor). In other examples, a ring 104 that includes additional sensors and processing functionality may be fabricated.

The housing 205 may include one or more housing 205 components. The housing 205 may include an outer housing 205-b component (e.g., a shell) and an inner housing 205-a component (e.g., a molding). The housing 205 may include additional components (e.g., additional layers) not explicitly illustrated in FIG. 2. For example, in some implementations, the ring 104 may include one or more insulating layers that electrically insulate the device electronics and other conductive materials (e.g., electrical traces) from the outer housing 205-b (e.g., a metal outer housing 205-b). The housing 205 may provide structural support for the device electronics, battery 210, substrate(s), and other components. For example, the housing 205 may protect the device electronics, battery 210, and substrate(s) from mechanical forces, such as pressure and impacts. The housing 205 may also protect the device electronics, battery 210, and substrate(s) from water and/or other chemicals.

The outer housing 205-b may be fabricated from one or more materials. In some implementations, the outer housing 205-b may include a metal, such as titanium, that may provide strength and abrasion resistance at a relatively light weight. The outer housing 205-b may also be fabricated from other materials, such polymers. In some implementations, the outer housing 205-b may be protective as well as decorative.

The inner housing 205-a may be configured to interface with the user's finger. The inner housing 205-a may be formed from a polymer (e.g., a medical grade polymer) or other material. In some implementations, the inner housing 205-a may be transparent. For example, the inner housing 205-a may be transparent to light emitted by the PPG light emitting diodes (LEDs). In some implementations, the inner housing 205-a component may be molded onto the outer housing 205-b. For example, the inner housing 205-a may include a polymer that is molded (e.g., injection molded) to fit into an outer housing 205-b metallic shell.

The ring 104 may include one or more substrates (not illustrated). The device electronics and battery 210 may be included on the one or more substrates. For example, the device electronics and battery 210 may be mounted on one or more substrates. Example substrates may include one or more printed circuit boards (PCBs), such as flexible PCB (e.g., polyimide). In some implementations, the electronics/battery 210 may include surface mounted devices (e.g., surface-mount technology (SMT) devices) on a flexible PCB. In some implementations, the one or more substrates (e.g., one or more flexible PCBs) may include electrical traces that provide electrical communication between device electronics. The electrical traces may also connect the battery 210 to the device electronics.

The device electronics, battery 210, and substrates may be arranged in the ring 104 in a variety of ways. In some implementations, one substrate that includes device electronics may be mounted along the bottom of the ring 104 (e.g., the bottom half), such that the sensors (e.g., PPG system 235, temperature sensors 240, motion sensors 245, and other sensors) interface with the underside of the user's finger. In these implementations, the battery 210 may be included along the top portion of the ring 104 (e.g., on another substrate).

The various components/modules of the ring 104 represent functionality (e.g., circuits and other components) that may be included in the ring 104. Modules may include any discrete and/or integrated electronic circuit components that implement analog and/or digital circuits capable of producing the functions attributed to the modules herein. For example, the modules may include analog circuits (e.g., amplification circuits, filtering circuits, analog/digital conversion circuits, and/or other signal conditioning circuits). The modules may also include digital circuits (e.g., combinational or sequential logic circuits, memory circuits etc.).

The memory 215 (memory module) of the ring 104 may include any volatile, non-volatile, magnetic, or electrical media, such as a random access memory (RAM), read-only memory (ROM), non-volatile RAM (NVRAM), electrically-erasable programmable ROM (EEPROM), flash memory, or any other memory device. The memory 215 may store any of the data described herein. For example, the memory 215 may be configured to store data (e.g., motion data, temperature data, PPG data) collected by the respective sensors and PPG system 235. Furthermore, memory 215 may include instructions that, when executed by one or more processing circuits, cause the modules to perform various functions attributed to the modules herein. The device electronics of the ring 104 described herein are only example device electronics. As such, the types of electronic components used to implement the device electronics may vary based on design considerations.

The functions attributed to the modules of the ring 104 described herein may be embodied as one or more processors, hardware, firmware, software, or any combination thereof. Depiction of different features as modules is intended to highlight different functional aspects and does not necessarily imply that such modules must be realized by separate hardware/software components. Rather, functionality associated with one or more modules may be performed by separate hardware/software components or integrated within common hardware/software components.

The processing module 230-a of the ring 104 may include one or more processors (e.g., processing units), microcontrollers, digital signal processors, systems on a chip (SOCs), and/or other processing devices. The processing module 230-a communicates with the modules included in the ring 104. For example, the processing module 230-a may transmit/receive data to/from the modules and other components of the ring 104, such as the sensors. As described herein, the modules may be implemented by various circuit components. Accordingly, the modules may also be referred to as circuits (e.g., a communication circuit and power circuit).

The processing module 230-a may communicate with the memory 215. The memory 215 may include computer-readable instructions that, when executed by the processing module 230-a, cause the processing module 230-a to perform the various functions attributed to the processing module 230-a herein. In some implementations, the processing module 230-a (e.g., a microcontroller) may include additional features associated with other modules, such as communication functionality provided by the communication module 220-a (e.g., an integrated Bluetooth Low Energy transceiver) and/or additional onboard memory 215.

The communication module 220-a may include circuits that provide wireless and/or wired communication with the user device 106 (e.g., communication module 220-b of the user device 106). In some implementations, the communication modules 220-a, 220-b may include wireless communication circuits, such as Bluetooth circuits and/or Wi-Fi circuits. In some implementations, the communication modules 220-a, 220-b can include wired communication circuits, such as Universal Serial Bus (USB) communication circuits. Using the communication module 220-a, the ring 104 and the user device 106 may be configured to communicate with each other. The processing module 230-a of the ring may be configured to transmit/receive data to/from the user device 106 via the communication module 220-a. Example data may include, but is not limited to, motion data, temperature data, pulse waveforms, heart rate data, HRV data, PPG data, and status updates (e.g., charging status, battery charge level, and/or ring 104 configuration settings). The processing module 230-a of the ring may also be configured to receive updates (e.g., software/firmware updates) and data from the user device 106.

The ring 104 may include a battery 210 (e.g., a rechargeable battery 210). An example battery 210 may include a Lithium-Ion or Lithium-Polymer type battery 210, although a variety of battery 210 options are possible. The battery 210 may be wirelessly charged. In some implementations, the ring 104 may include a power source other than the battery 210, such as a capacitor. The power source (e.g., battery 210 or capacitor) may have a curved geometry that matches the curve of the ring 104. In some aspects, a charger or other power source may include additional sensors that may be used to collect data in addition to, or that supplements, data collected by the ring 104 itself. Moreover, a charger or other power source for the ring 104 may function as a user device 106, in which case the charger or other power source for the ring 104 may be configured to receive data from the ring 104, store and/or process data received from the ring 104, and communicate data between the ring 104 and the servers 110.

In some aspects, the ring 104 includes a power module 225 that may control charging of the battery 210. For example, the power module 225 may interface with an external wireless charger that charges the battery 210 when interfaced with the ring 104. The charger may include a datum structure that mates with a ring 104 datum structure to create a specified orientation with the ring 104 during charging. The power module 225 may also regulate voltage(s) of the device electronics, regulate power output to the device electronics, and monitor the state of charge of the battery 210. In some implementations, the battery 210 may include a protection circuit module (PCM) that protects the battery 210 from high current discharge, over voltage during charging, and under voltage during discharge. The power module 225 may also include electro-static discharge (ESD) protection.

The one or more temperature sensors 240 may be electrically coupled to the processing module 230-a. The temperature sensor 240 may be configured to generate a temperature signal (e.g., temperature data) that indicates a temperature read or sensed by the temperature sensor 240. The processing module 230-a may determine a temperature of the user in the location of the temperature sensor 240. For example, in the ring 104, temperature data generated by the temperature sensor 240 may indicate a temperature of a user at the user's finger (e.g., skin temperature). In some implementations, the temperature sensor 240 may contact the user's skin. In other implementations, a portion of the housing 205 (e.g., the inner housing 205-a) may form a barrier (e.g., a thin, thermally conductive barrier) between the temperature sensor 240 and the user's skin. In some implementations, portions of the ring 104 configured to contact the user's finger may have thermally conductive portions and thermally insulative portions. The thermally conductive portions may conduct heat from the user's finger to the temperature sensors 240. The thermally insulative portions may insulate portions of the ring 104 (e.g., the temperature sensor 240) from ambient temperature.

In some implementations, the temperature sensor 240 may generate a digital signal (e.g., temperature data) that the processing module 230-a may use to determine the temperature. As another example, in cases where the temperature sensor 240 includes a passive sensor, the processing module 230-a (or a temperature sensor 240 module) may measure a current/voltage generated by the temperature sensor 240 and determine the temperature based on the measured current/voltage. Example temperature sensors 240 may include a thermistor, such as a negative temperature coefficient (NTC) thermistor, or other types of sensors including resistors, transistors, diodes, and/or other electrical/electronic components.

The processing module 230-a may sample the user's temperature over time. For example, the processing module 230-a may sample the user's temperature according to a sampling rate. An example sampling rate may include one sample per second, although the processing module 230-a may be configured to sample the temperature signal at other sampling rates that are higher or lower than one sample per second. In some implementations, the processing module 230-a may sample the user's temperature continuously throughout the day and night. Sampling at a sufficient rate (e.g., one sample per second) throughout the day may provide sufficient temperature data for analysis described herein.

The processing module 230-a may store the sampled temperature data in memory 215. In some implementations, the processing module 230-a may process the sampled temperature data. For example, the processing module 230-a may determine average temperature values over a period of time. In one example, the processing module 230-a may determine an average temperature value each minute by summing all temperature values collected over the minute and dividing by the number of samples over the minute. In a specific example where the temperature is sampled at one sample per second, the average temperature may be a sum of all sampled temperatures for one minute divided by sixty seconds. The memory 215 may store the average temperature values over time. In some implementations, the memory 215 may store average temperatures (e.g., one per minute) instead of sampled temperatures in order to conserve memory 215.

The sampling rate, which may be stored in memory 215, may be configurable. In some implementations, the sampling rate may be the same throughout the day and night. In other implementations, the sampling rate may be changed throughout the day/night. In some implementations, the ring 104 may filter/reject temperature readings, such as large spikes in temperature that are not indicative of physiological changes (e.g., a temperature spike from a hot shower). In some implementations, the ring 104 may filter/reject temperature readings that may not be reliable due to other factors, such as excessive motion during exercise (e.g., as indicated by a motion sensor 245).

The ring 104 (e.g., communication module) may transmit the sampled and/or average temperature data to the user device 106 for storage and/or further processing. The user device 106 may transfer the sampled and/or average temperature data to the server 110 for storage and/or further processing.

Although the ring 104 is illustrated as including a single temperature sensor 240, the ring 104 may include multiple temperature sensors 240 in one or more locations, such as arranged along the inner housing 205-a near the user's finger. In some implementations, the temperature sensors 240 may be stand-alone temperature sensors 240. Additionally, or alternatively, one or more temperature sensors 240 may be included with other components (e.g., packaged with other components), such as with the accelerometer and/or processor.

The processing module 230-a may acquire and process data from multiple temperature sensors 240 in a similar manner described with respect to a single temperature sensor 240. For example, the processing module 230 may individually sample, average, and store temperature data from each of the multiple temperature sensors 240. In other examples, the processing module 230-a may sample the sensors at different rates and average/store different values for the different sensors. In some implementations, the processing module 230-a may be configured to determine a single temperature based on the average of two or more temperatures determined by two or more temperature sensors 240 in different locations on the finger.

The temperature sensors 240 on the ring 104 may acquire distal temperatures at the user's finger (e.g., any finger). For example, one or more temperature sensors 240 on the ring 104 may acquire a user's temperature from the underside of a finger or at a different location on the finger. In some implementations, the ring 104 may continuously acquire distal temperature (e.g., at a sampling rate). Although distal temperature measured by a ring 104 at the finger is described herein, other devices may measure temperature at the same/different locations. In some cases, the distal temperature measured at a user's finger may differ from the temperature measured at a user's wrist or other external body location. Additionally, the distal temperature measured at a user's finger (e.g., a “shell” temperature) may differ from the user's core temperature. As such, the ring 104 may provide a useful temperature signal that may not be acquired at other internal/external locations of the body. In some cases, continuous temperature measurement at the finger may capture temperature fluctuations (e.g., small or large fluctuations) that may not be evident in core temperature. For example, continuous temperature measurement at the finger may capture minute-to-minute or hour-to-hour temperature fluctuations that provide additional insight that may not be provided by other temperature measurements elsewhere in the body.

The ring 104 may include a PPG system 235. The PPG system 235 may include one or more optical transmitters that transmit light. The PPG system 235 may also include one or more optical receivers that receive light transmitted by the one or more optical transmitters. An optical receiver may generate a signal (hereinafter “PPG” signal) that indicates an amount of light received by the optical receiver. The optical transmitters may illuminate a region of the user's finger. The PPG signal generated by the PPG system 235 may indicate the perfusion of blood in the illuminated region. For example, the PPG signal may indicate blood volume changes in the illuminated region caused by a user's pulse pressure. The processing module 230-a may sample the PPG signal and determine a user's pulse waveform based on the PPG signal. The processing module 230-a may determine a variety of physiological parameters based on the user's pulse waveform, such as a user's respiratory rate, heart rate, HRV, oxygen saturation, and other circulatory parameters.

In some implementations, the PPG system 235 may be configured as a reflective PPG system 235 where the optical receiver(s) receive transmitted light that is reflected through the region of the user's finger. In some implementations, the PPG system 235 may be configured as a transmissive PPG system 235 where the optical transmitter(s) and optical receiver(s) are arranged opposite to one another, such that light is transmitted directly through a portion of the user's finger to the optical receiver(s).

The number and ratio of transmitters and receivers included in the PPG system 235 may vary. Example optical transmitters may include light-emitting diodes (LEDs). The optical transmitters may transmit light in the infrared spectrum and/or other spectrums. Example optical receivers may include, but are not limited to, photosensors, phototransistors, and photodiodes. The optical receivers may be configured to generate PPG signals in response to the wavelengths received from the optical transmitters. The location of the transmitters and receivers may vary. Additionally, a single device may include reflective and/or transmissive PPG systems 235.

The PPG system 235 illustrated in FIG. 2 may include a reflective PPG system 235 in some implementations. In these implementations, the PPG system 235 may include a centrally located optical receiver (e.g., at the bottom of the ring 104) and two optical transmitters located on each side of the optical receiver. In this implementation, the PPG system 235 (e.g., optical receiver) may generate the PPG signal based on light received from one or both of the optical transmitters. In other implementations, other placements, combinations, and/or configurations of one or more optical transmitters and/or optical receivers are contemplated.

The processing module 230-a may control one or both of the optical transmitters to transmit light while sampling the PPG signal generated by the optical receiver. In some implementations, the processing module 230-a may cause the optical transmitter with the stronger received signal to transmit light while sampling the PPG signal generated by the optical receiver. For example, the selected optical transmitter may continuously emit light while the PPG signal is sampled at a sampling rate (e.g., 250 Hz).

Sampling the PPG signal generated by the PPG system 235 may result in a pulse waveform that may be referred to as a “PPG.” The pulse waveform may indicate blood pressure vs time for multiple cardiac cycles. The pulse waveform may include peaks that indicate cardiac cycles. Additionally, the pulse waveform may include respiratory induced variations that may be used to determine respiration rate. The processing module 230-a may store the pulse waveform in memory 215 in some implementations. The processing module 230-a may process the pulse waveform as it is generated and/or from memory 215 to determine user physiological parameters described herein.

The processing module 230-a may determine the user's heart rate based on the pulse waveform. For example, the processing module 230-a may determine heart rate (e.g., in beats per minute) based on the time between peaks in the pulse waveform. The time between peaks may be referred to as an interbeat interval (IBI). The processing module 230-a may store the determined heart rate values and IBI values in memory 215.

The processing module 230-a may determine HRV over time. For example, the processing module 230-a may determine HRV based on the variation in the IBIs. The processing module 230-a may store the HRV values over time in the memory 215. Moreover, the processing module 230-a may determine the user's respiratory rate over time. For example, the processing module 230-a may determine respiratory rate based on frequency modulation, amplitude modulation, or baseline modulation of the user's IBI values over a period of time. Respiratory rate may be calculated in breaths per minute or as another breathing rate (e.g., breaths per 30 seconds). The processing module 230-a may store user respiratory rate values over time in the memory 215.

The ring 104 may include one or more motion sensors 245, such as one or more accelerometers (e.g., 6-D accelerometers) and/or one or more gyroscopes (gyros). The motion sensors 245 may generate motion signals that indicate motion of the sensors. For example, the ring 104 may include one or more accelerometers that generate acceleration signals that indicate acceleration of the accelerometers. As another example, the ring 104 may include one or more gyro sensors that generate gyro signals that indicate angular motion (e.g., angular velocity) and/or changes in orientation. The motion sensors 245 may be included in one or more sensor packages. An example accelerometer/gyro sensor is a Bosch BMl160 inertial micro electro-mechanical system (MEMS) sensor that may measure angular rates and accelerations in three perpendicular axes.

The processing module 230-a may sample the motion signals at a sampling rate (e.g., 50 Hz) and determine the motion of the ring 104 based on the sampled motion signals. For example, the processing module 230-a may sample acceleration signals to determine acceleration of the ring 104. As another example, the processing module 230-a may sample a gyro signal to determine angular motion. In some implementations, the processing module 230-a may store motion data in memory 215. Motion data may include sampled motion data as well as motion data that is calculated based on the sampled motion signals (e.g., acceleration and angular values).

The ring 104 may store a variety of data described herein. For example, the ring 104 may store temperature data, such as raw sampled temperature data and calculated temperature data (e.g., average temperatures). As another example, the ring 104 may store PPG signal data, such as pulse waveforms and data calculated based on the pulse waveforms (e.g., heart rate values, IBI values, HRV values, and respiratory rate values). The ring 104 may also store motion data, such as sampled motion data that indicates linear and angular motion.

The ring 104, or other computing device, may calculate and store additional values based on the sampled/calculated physiological data. For example, the processing module 230 may calculate and store various metrics, such as sleep metrics (e.g., a Sleep Score), activity metrics, and readiness metrics. In some implementations, additional values/metrics may be referred to as “derived values.” The ring 104, or other computing/wearable device, may calculate a variety of values/metrics with respect to motion. Example derived values for motion data may include, but are not limited to, motion count values, regularity values, intensity values, metabolic equivalence of task values (METs), and orientation values. Motion counts, regularity values, intensity values, and METs may indicate an amount of user motion (e.g., velocity/acceleration) over time. Orientation values may indicate how the ring 104 is oriented on the user's finger and if the ring 104 is worn on the left hand or right hand.

In some implementations, motion counts and regularity values may be determined by counting a number of acceleration peaks within one or more periods of time (e.g., one or more 30 second to 1 minute periods). Intensity values may indicate a number of movements and the associated intensity (e.g., acceleration values) of the movements. The intensity values may be categorized as low, medium, and high, depending on associated threshold acceleration values. METs may be determined based on the intensity of movements during a period of time (e.g., 30 seconds), the regularity/irregularity of the movements, and the number of movements associated with the different intensities.

In some implementations, the processing module 230-a may compress the data stored in memory 215. For example, the processing module 230-a may delete sampled data after making calculations based on the sampled data. As another example, the processing module 230-a may average data over longer periods of time in order to reduce the number of stored values. In a specific example, if average temperatures for a user over one minute are stored in memory 215, the processing module 230-a may calculate average temperatures over a five minute time period for storage, and then subsequently erase the one minute average temperature data. The processing module 230-a may compress data based on a variety of factors, such as the total amount of used/available memory 215 and/or an elapsed time since the ring 104 last transmitted the data to the user device 106.

Although a user's physiological parameters may be measured by sensors included on a ring 104, other devices may measure a user's physiological parameters. For example, although a user's temperature may be measured by a temperature sensor 240 included in a ring 104, other devices may measure a user's temperature. In some examples, other wearable devices (e.g., wrist devices) may include sensors that measure user physiological parameters. Additionally, medical devices, such as external medical devices (e.g., wearable medical devices) and/or implantable medical devices, may measure a user's physiological parameters. One or more sensors on any type of computing device may be used to implement the techniques described herein.

The physiological measurements may be taken continuously throughout the day and/or night. In some implementations, the physiological measurements may be taken during portions of the day and/or portions of the night. In some implementations, the physiological measurements may be taken in response to determining that the user is in a specific state, such as an active state, resting state, and/or a sleeping state. For example, the ring 104 can make physiological measurements in a resting/sleep state in order to acquire cleaner physiological signals. In one example, the ring 104 or other device/system may detect when a user is resting and/or sleeping and acquire physiological parameters (e.g., temperature) for that detected state. The devices/systems may use the resting/sleep physiological data and/or other data when the user is in other states in order to implement the techniques of the present disclosure.

In some implementations, as described previously herein, the ring 104 may be configured to collect, store, and/or process data, and may transfer any of the data described herein to the user device 106 for storage and/or processing. In some aspects, the user device 106 includes a wearable application 250, an operating system (OS) 285, a web browser application (e.g., web browser 280), one or more additional applications, and a GUI 275. The user device 106 may further include other modules and components, including sensors, audio devices, haptic feedback devices, and the like. The wearable application 250 may include an example of an application (e.g., “app”) that may be installed on the user device 106. The wearable application 250 may be configured to acquire data from the ring 104, store the acquired data, and process the acquired data as described herein. For example, the wearable application 250 may include a user interface (UI) module 255, an acquisition module 260, a processing module 230-b, a communication module 220-b, and a storage module (e.g., database 265) configured to store application data.

In some cases, the wearable device 104 and the user device 106 may be included within (or make up) the same device. For example, in some cases, the wearable device 104 may be configured to execute the wearable application 250, and may be configured to display data via the GUI 275.

The various data processing operations described herein may be performed by the ring 104, the user device 106, the servers 110, or any combination thereof. For example, in some cases, data collected by the ring 104 may be pre-processed and transmitted to the user device 106. In this example, the user device 106 may perform some data processing operations on the received data, may transmit the data to the servers 110 for data processing, or both. For instance, in some cases, the user device 106 may perform processing operations that require relatively low processing power and/or operations that require a relatively low latency, whereas the user device 106 may transmit the data to the servers 110 for processing operations that require relatively high processing power and/or operations that may allow relatively higher latency.

In some aspects, the ring 104, user device 106, and server 110 of the system 200 may be configured to evaluate sleep patterns for a user. In particular, the respective components of the system 200 may be used to collect data from a user via the ring 104, and generate one or more scores (e.g., Sleep Score, Readiness Score) for the user based on the collected data. For example, as noted previously herein, the ring 104 of the system 200 may be worn by a user to collect data from the user, including temperature, heart rate, HRV, and the like. Data collected by the ring 104 may be used to determine when the user is asleep in order to evaluate the user's sleep for a given “sleep day.” In some aspects, scores may be calculated for the user for each respective sleep day, such that a first sleep day is associated with a first set of scores, and a second sleep day is associated with a second set of scores. Scores may be calculated for each respective sleep day based on data collected by the ring 104 during the respective sleep day. Scores may include, but are not limited to, Sleep Scores, Readiness Scores, and the like.

In some cases, “sleep days” may align with the traditional calendar days, such that a given sleep day runs from midnight to midnight of the respective calendar day. In other cases, sleep days may be offset relative to calendar days. For example, sleep days may run from 6:00 pm (18:00) of a calendar day until 6:00 pm (18:00) of the subsequent calendar day. In this example, 6:00 pm may serve as a “cut-off time,” where data collected from the user before 6:00 pm is counted for the current sleep day, and data collected from the user after 6:00 pm is counted for the subsequent sleep day. Due to the fact that most individuals sleep the most at night, offsetting sleep days relative to calendar days may enable the system 200 to evaluate sleep patterns for users in such a manner that is consistent with their sleep schedules. In some cases, users may be able to selectively adjust (e.g., via the GUI) a timing of sleep days relative to calendar days so that the sleep days are aligned with the duration of time that the respective users typically sleep.

In some implementations, each overall score for a user for each respective day (e.g., Sleep Score, Readiness Score) may be determined/calculated based on one or more “contributors,” “factors,” or “contributing factors.” For example, a user's overall Sleep Score may be calculated based on a set of contributors, including: total sleep, efficiency, restfulness, REM sleep, deep sleep, latency, timing, or any combination thereof. The Sleep Score may include any quantity of contributors. The “total sleep” contributor may refer to the sum of all sleep periods of the sleep day. The “efficiency” contributor may reflect the percentage of time spent asleep compared to time spent awake while in bed, and may be calculated using the efficiency average of long sleep periods (e.g., primary sleep period) of the sleep day, weighted by a duration of each sleep period. The “restfulness” contributor may indicate how restful the user's sleep is, and may be calculated using the average of all sleep periods of the sleep day, weighted by a duration of each period. The restfulness contributor may be based on a “wake up count” (e.g., sum of all the wake-ups (when user wakes up) detected during different sleep periods), excessive movement, and a “got up count” (e.g., sum of all the got-ups (when user gets out of bed) detected during the different sleep periods).

The “REM sleep” contributor may refer to a sum total of REM sleep durations across all sleep periods of the sleep day including REM sleep. Similarly, the “deep sleep” contributor may refer to a sum total of deep sleep durations across all sleep periods of the sleep day including deep sleep. The “latency” contributor may signify how long (e.g., average, median, longest) the user takes to go to sleep, and may be calculated using the average of long sleep periods throughout the sleep day, weighted by a duration of each period and the number of such periods (e.g., consolidation of a given sleep stage or sleep stages may be its own contributor or weight other contributors). Lastly, the “timing” contributor may refer to a relative timing of sleep periods within the sleep day and/or calendar day, and may be calculated using the average of all sleep periods of the sleep day, weighted by a duration of each period.

By way of another example, a user's overall Readiness Score may be calculated based on a set of contributors, including: sleep, sleep balance, heart rate, HRV balance, recovery index, temperature, activity, activity balance, or any combination thereof. The Readiness Score may include any quantity of contributors. The “sleep” contributor may refer to the combined Sleep Score of all sleep periods within the sleep day. The “sleep balance” contributor may refer to a cumulative duration of all sleep periods within the sleep day. In particular, sleep balance may indicate to a user whether the sleep that the user has been getting over some duration of time (e.g., the past two weeks) is in balance with the user's needs. Typically, adults need 7-9 hours of sleep a night to stay healthy, alert, and to perform at their best both mentally and physically. However, it is normal to have an occasional night of bad sleep, so the sleep balance contributor takes into account long-term sleep patterns to determine whether each user's sleep needs are being met. The “resting heart rate” contributor may indicate a lowest heart rate from the longest sleep period of the sleep day (e.g., primary sleep period) and/or the lowest heart rate from naps occurring after the primary sleep period.

Continuing with reference to the “contributors” (e.g., factors, contributing factors) of the Readiness Score, the “HRV balance” contributor may indicate a highest HRV average from the primary sleep period and the naps happening after the primary sleep period. The HRV balance contributor may help users keep track of their recovery status by comparing their HRV trend over a first time period (e.g., two weeks) to an average HRV over some second, longer time period (e.g., three months). The “recovery index” contributor may be calculated based on the longest sleep period. Recovery index measures how long it takes for a user's resting heart rate to stabilize during the night. A sign of a very good recovery is that the user's resting heart rate stabilizes during the first half of the night, at least six hours before the user wakes up, leaving the body time to recover for the next day. The “body temperature” contributor may be calculated based on the longest sleep period (e.g., primary sleep period) or based on a nap happening after the longest sleep period if the user's highest temperature during the nap is at least 0.5° C. higher than the highest temperature during the longest period. In some aspects, the ring may measure a user's body temperature while the user is asleep, and the system 200 may display the user's average temperature relative to the user's baseline temperature. If a user's body temperature is outside of their normal range (e.g., clearly above or below 0.0), the body temperature contributor may be highlighted (e.g., go to a “Pay attention” state) or otherwise generate an alert for the user.

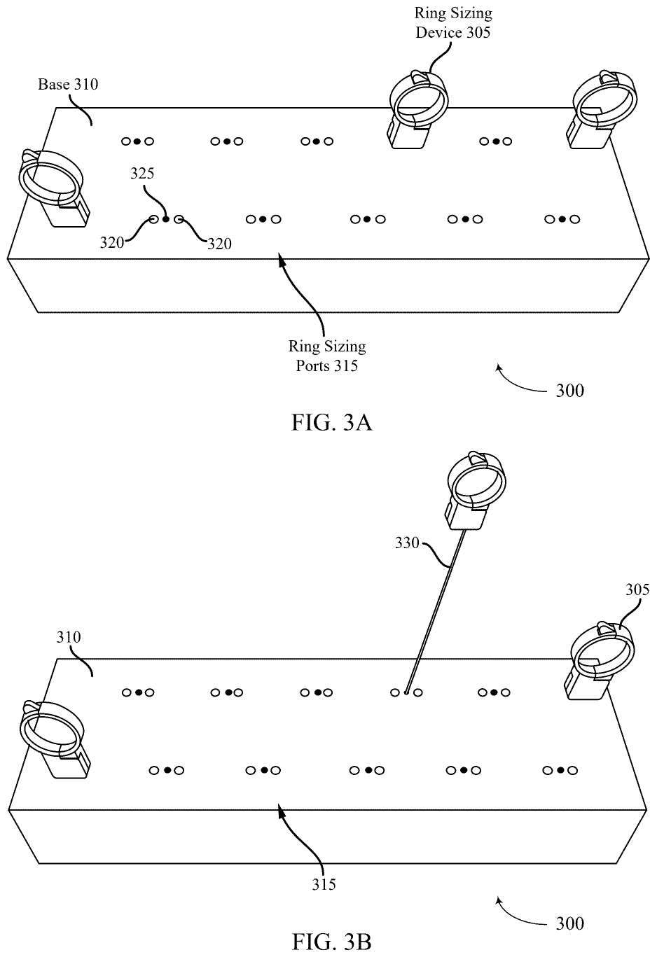

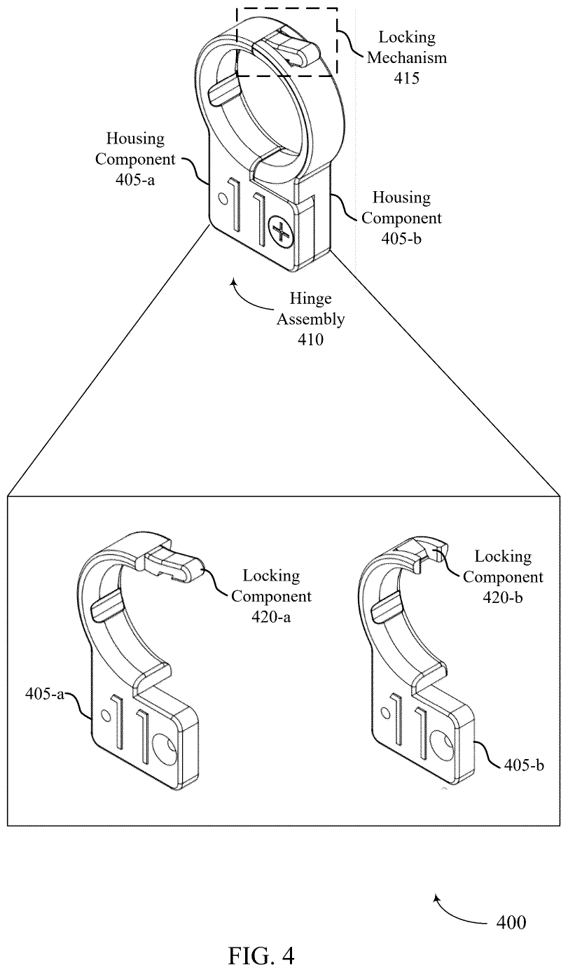

In some aspects, the devices of the system 200, such as the wearable ring device 104, may come in fixed sizes, where users 102 may use a sizing kit (e.g., retail sizing assembly) that includes multiple ring sizing devices corresponding to multiple ring sizes. That is, the system 100 may include or may otherwise support a sizing kit/retail sizing assembly that users can utilize to determine the size of wearable ring device 104 that accurately fits their finger(s). Example ring sizing assemblies and example ring sizing devices are further shown and described with reference to FIGS. 3 and 4.

FIGS. 3A and 3B show examples of a retail sizing assembly 300 of a retail sizing system for wearable ring devices in accordance with aspects of the present disclosure. Aspects of the retail sizing assembly 300 may implement, or be implemented by, aspects of the system 100, the system 200, or both.

The retail sizing assembly 300 illustrated in FIGS. 3A and 3B may be an example of a “sizing kit” that may be implemented within a retail establishment to enable users to find which size of wearable ring device they should purchase. The retail sizing assembly 300 may include a base 310 and a set of ring sizing devices 305. In some aspects, each respective ring sizing device 305 may be manufactured to model or simulate a respective ring size (e.g., ring sizes 4-15). That is, each respective ring sizing device 305 may exhibit an opening and/or inner curved surface (e.g., inner circumference) that substantially conforms to a size/inner surface of a corresponding ring size.

In this regard, users may be able to try on the various ring sizing devices 305 to determine which size of wearable ring device best suits their finger(s). In some cases, wearable ring devices may be manufactured with “domes” or other protrusions on the inner surface of the ring that are used to increase contact with the user's tissue. For example, the LEDs and photodetectors of a wearable ring device may be positioned within or beneath molded epoxy or glass “domes,” where the domes are configured to increase contact with the user's tissue and therefore provide improved optical interfaces for transmission and reception of light into and out of the user's tissue. In such cases, the ring sizing devices 305 may be manufactured with similar “domes” or protrusions on the inner curved surface of the respective ring sizing devices 305, where the domes/protrusions are based on (e.g., mimic, mirror) the position, size, and shape of the domes/protrusions of the real ring device.

As will be further described herein, each respective ring sizing device 305 may be configured to transition between a closed configuration (as shown in FIGS. 3A and 3B) and an open configuration. The ring sizing devices 305 may be configured to model the shape and size of corresponding wearable ring devices while in the closed configuration (for accurate sizing), and may be configured to transition to the open configuration to enable the user to safely and easily remove their finger from the respective ring sizing device 305. As further shown and described in FIG. 4, each ring sizing device 305 may include separate housing components that are configured to move relative to one another in order to transition the respective ring sizing device 305 between the closed configuration and the open configuration.

The base 310 may include a set of ring sizing ports 315 configured to receive the respective ring sizing devices 305. For example, as shown in FIGS. 3A and 3B, the base 310 may include ring sizing ports 315 that correspond to twelve different ring sizing devices 305 for wearable ring sizes 4-15 (or some other range of ring sizes). In some aspects, each respective ring sizing port 315 may include one or more magnets 320 that are configured to engage with magnets within the respective ring sizing device 305. The magnets 320 within the base 310 (and within the ring sizing devices 305) may be configured to retain the ring sizing devices on/within the ring sizing ports 315 when the ring sizing devices 305 are not being used, and to help orient each of the ring sizing devices in the same direction (or otherwise orient each of the ring sizing devices in some predetermined direction). For example, as shown in FIG. 3A, the magnets 320 may be configured to maintain each of the ring sizing devices 305 in an upright position (e.g., perpendicular/normal to a surface of the base 310) and facing in all the same direction (e.g., with the “tabs” at the top of the ring sizing devices 305 all facing to the left). In this regard, the magnets 320 may help keep the ring sizing devices 305 in an organized and aesthetically pleasing pattern. By way of another example, all ring sizing devices 305 to the right of a midpoint of the retail sizing assembly 300 may be rotated X° clockwise, whereas all ring sizing devices 305 to the left of a midpoint of the retail sizing assembly 300 may be rotated X° counterclockwise. In this regard, the orientation of the ring sizing devices 305 may be different, but may nonetheless be arranged in an aesthetically pleasing manner (e.g., symmetrically).

In some cases, the magnets 320 may be disposed within, or otherwise hidden beneath, a surface of the base 310. For example, in some cases, the magnets 320 may be covered with a sheet or some other coating so that the magnets 320 are not visible to users, but so that the magnets 320 are able to attract or otherwise interact with the magnets disposed within the ring sizing devices 305 (e.g., through the sheet/coating).

In some cases, the ring sizing ports 315 may include dedicated locations on a flat surface of the base 310 that are designated and/or labeled for the respective ring sizing devices 305. In additional or other cases, the ring sizing ports 315 may include recesses, cavities, channels, or other physical features that help maintain the ring sizing devices 305 on/within the ring sizing ports 315, and that help orient the ring sizing devices 305 in the same direction/orientation. For example, each ring sizing port 315 may include a “channel” that approximately corresponds to a width of the respective ring sizing device 305 so that the ring sizing device 305 fits into the channel, and so that the side walls of the channel help retain the ring sizing device 305 in an upright position.

In some aspects, each ring sizing port 315 may include an aperture 325 and a retractable cable mechanism 330 that extends through an aperture 325 and connects with the respective ring sizing device 305. For example, as shown in FIG. 3B, each ring sizing port 315 may include an aperture and a magnet disposed on each lateral side of the aperture 325 opposite one another. The retractable cable mechanisms 330 may be configured to retain the ring sizing devices 305 against the ring sizing ports 315 when the retractable cable mechanisms 330 are in a retracted configuration, and may be configured to enable limited movement of the ring sizing devices 305 relative to the base 310 when in an extended configuration. That is, the retractable cable mechanisms 330 may enable users to pull the ring sizing devices 305 away from the base 310 so that the user can comfortably try on the ring sizing device 305. After the user is done trying on the ring sizing device 305, the retractable cable mechanism 330 may retract (e.g., revert to a retracted configuration) to pull the ring sizing device 305 back to its designated ring sizing port 315 on/within the base 310.

In some cases, the retractable cable mechanisms 330 may further help maintain the ring sizing devices 305 against the ring sizing ports 315 and orient the ring sizing devices 305 in the defined direction/orientation. For example, in cases where the user twists the ring sizing device 305 (e.g., applies a rotational force on the ring sizing device 305/retractable cable mechanism 330), the retractable cable mechanism 330 may be configured to “unwind” itself (e.g., exert a rotational force in the opposite direction) to maintain the ring sizing device 305 in the correct orientation when it is returned to the retracted position on/within the base 310.

In some aspects, the base 310 may include one or more stopping mechanisms that are configured to maintain at least one retractable cable mechanism 330 in an extended configuration (e.g., for improved user comfort when trying on the ring sizing devices 305). For example, the user may be able to press some button or lever on/within the base 310 to maintain the retractable cable mechanism 330 in an extended configuration while the user tries on the corresponding ring sizing device 305.

FIG. 4 shows an example of a ring sizing device 400 of a retail sizing system for wearable ring devices in accordance with aspects of the present disclosure. Aspects of the ring sizing device 400 may implement, or be implemented by, aspects of the system 100, the system 200, the retail sizing assembly 300, or any combination thereof. For example, the ring sizing device 400 illustrated in FIG. 4 may be an example of the ring sizing devices 305 shown and described in FIGS. 3A and 3B.

In some aspects, each ring sizing device 400 may include two housing components 405 (e.g., made of a metal material, a plastic material, ceramic material, etc.), including a first housing component 405-a and a second housing component 405-b. The housing components 405-a, 405-b of each respective ring sizing device 400 may be coupled to one other via a hinge assembly 410 (e.g., hinge) to enable the housing component 405-a to move relative to the housing component 405-b, and to further enable the ring sizing devices 400 to transition between a closed configuration (e.g., configuration used for determining the user's ring size) and an open configuration (e.g., configuration for safely removing the user's finger from the ring sizing device 400). In such cases, when in the closed configuration, the ring sizing device 400 may mimic a wearable ring device form factor. That is, in the closed configuration, the housing component 405-a and the housing component 405-b may form a closed loop (e.g., opening) with a first inner curved surface (e.g., first inner circumference, inner diameter) that is the same as an inner circumference of a specific size of a wearable ring device 104. For instance, the ring sizing device 400 illustrated in FIG. 4 may mimic the shape and size of a ring size 11 when in the closed configuration.

Conversely, in the open configuration, a discontinuity, or gap, may be created between the housing component 405-a and the housing component 405-b (e.g., at ends opposite of the hinge assembly 410), such that the housing component 405-a and the housing component 405-b may form a discontinuous loop with a second inner diameter/circumference that is larger than the first inner diameter/circumference. In other words, the inner circumference/diameter of the ring sizing device 400 may expand when it is transitioned to the open configuration to enable the ring sizing device 400 to be safely and comfortably removed from the user's finger.

To retain the ring sizing devices 400 in the closed configuration (e.g., under certain conditions), the ends of the housing components 405 opposite from the hinge assembly 410 may be coupled (e.g., connected, engages, locked) to one another via a locking mechanism 415, including one or more locking components 420. In some cases, a locking mechanism 415-a of the ring sizing device 400 may include mechanical locking components 420, magnetic locking components 420, or both.

For example, the first housing component 405-a of the ring sizing device 400 may include a first locking component 420-a (e.g., a tab), and the second housing component 405-b of the ring sizing device 400 may include a second locking component 420-b (e.g., a recess or channel). In such cases, the first locking component 420-a may be configured to mechanically engage the second locking component 420-b (e.g., or visa-versa) to maintain the ring sizing device 400 in the closed configuration. Further, the first locking component 420-a may be configured to mechanically disengage the second locking component 420-b (e.g., or visa-versa) to transition the ring sizing device 400 from the closed configuration to the open configuration (to enable the user to remove their finger from the ring sizing device 400).

As shown in FIG. 4, the first locking component 420-a (e.g., tab) may exhibit a width that substantially conforms to a width of the channel of the second locking component 420-b. In such cases, frictional forces between the walls of the locking components 420 may help retain the ring sizing device 400 in the closed configuration for comfortable ring sizing. In additional or alternative implementation, the locking mechanism 415 may include magnets disposed within the respective housing components 405 that engage with one another and help retain the ring sizing device 400 in the closed configuration.

The locking mechanisms of the ring sizing devices 400 may be configured to retain the ring sizing device 400 in the closed configuration (e.g., for accurate ring sizing) until a threshold (e.g., sufficiently large) force is exerted on the ring sizing device 400, at which point the locking mechanisms 415 may disengage and enable the ring sizing device 400 to transition to the open configuration. For example, the locking mechanism 415 may keep the ring sizing device 400 in the closed configuration (e.g., via engagement of the locking component 420-a and the locking component 420-b) until a force that exceeds a first threshold is applied to the ring sizing device 400, at which point the locking component 420-a and the locking component 420-b may dis-engage. In such cases, the threshold may be based on a mechanical (and/or magnetic) strength of the locking component 420-a, the locking component 420-b, or both. In either cases, the threshold used to disengage the locking mechanism 415 may be applied by pulling the housing component 405-a and the housing component 405-b apart (e.g., in opposite or mirrored directions).

In this regard, as described previously, the locking mechanisms 415 may retain the ring sizing device 400 in the closed configuration as the user 102 tries on the ring sizing devices 400 (e.g., for accurate ring sizing). However, if the finger of the user 102 becomes stuck within the ring sizing device 400, the user 102 may exert a force greater than a threshold (e.g., the first threshold or the second threshold) to disengage the locking components 420 to pull apart the housing components 405 (e.g., transition the ring sizing device 400 to the open configuration) to enable the user 102 to safely remove their finger.

In some cases, the ring sizing device 400 may include a release component (e.g., one or more release components) coupled to or positioned at least partially within the housing component 405-a, the housing component 405-b, the hinge assembly 410, the locking mechanism 415 (e.g., the locking mechanism 415-a, the locking mechanism 415-b), or any combination thereof. In such cases, the release component may disengage (e.g., mechanically, magnetically, or both) the locking components 420 to transition the ring sizing device 400 from the closed configuration to the open configuration based on a third threshold force exerted on the release component.

For example, the release component may include a button (e.g., emergency button), such that the user 102 may transition a ring sizing device 400 from the closed configuration to the open configuration based on pressing the button and pulling the housing component 405-a and the housing component 405-b apart (e.g., at the locking mechanism 415). In another example, the release button may be a tab, such that the user 102 may transition a ring sizing device 400 from the closed configuration to the open configuration based on pulling (e.g., or pushing) the tab outwards (e.g., away from the ring) and pulling the housing component 405-a and the housing component 405-b apart (e.g., at the locking mechanism 415-a).

In some cases, the hinge assembly 410 may include one or more spring components. In such cases, the one or more spring components may return the ring sizing device 400 from the open configuration to the closed configuration when the force exceeding the threshold is removed. That is, after the user 102 removes their finger from the ring sizing device 400, the ring sizing device 400 may return to the closed configuration based contraction (or extension) of the one or more spring components.

In some aspects, as described previously herein, the ring sizing device 400 may include one or more magnets that are configured to engage the magnets 320 of a ring sizing port 315 of the base 310 illustrated in FIG. 3A. The magnets of the ring sizing device 400 may be disposed within the first housing component 405-a, the second housing component 405-b, or both. Further, in some aspects, the ring sizing device 400 may include a connector configured to couple with a retractable cable mechanism 330 shown and described in FIG. 3B. For example, the magnets and/or connector for the ring sizing device 400 may be positioned on a bottom surface of the ring sizing device 400 illustrated in FIG. 4 (e.g., on a bottom surface of the ring sizing device 400 adjacent to/below the size “11” marks in the side surface). In some cases, the first housing component 405-a, the second housing component 405-b, or both, may be formed with recesses configured to fit or accommodate the magnets and/or connector for the retractable cable mechanism 330.

It should be noted that the methods described herein describe possible implementations, and that the operations and the steps may be rearranged or otherwise modified and that other implementations are possible. Furthermore, aspects from two or more of the methods may be combined.

An apparatus of a ring sizing assembly is described. The apparatus may include a plurality of ring sizing devices each configured to transition between an open configuration and a closed configuration, wherein the plurality of ring sizing devices comprise a plurality of inner circumferences that correspond to a plurality of ring sizes when the plurality of ring sizing devices are in the closed configuration, wherein each respective ring sizing device of the plurality of ring sizing devices comprises, a locking assembly that is configured to maintain the respective ring sizing device in the closed configuration when a force exerted on the respective ring sizing device is less than a threshold, and transition the respective ring sizing device from the closed configuration to the open configuration when the force exceeds the threshold, one or more magnets, a base, comprising, a plurality of sizing ports configured to receive the plurality of ring sizing devices, a plurality of magnets corresponding the plurality of sizing ports, the plurality of magnets configured to engage the one or more magnets of each of the plurality of ring sizing devices to retain the plurality of ring sizing devices on or within the plurality of sizing ports and to orient each of the plurality of ring sizing devices in a same direction, and a plurality of retractable cable mechanisms disposed within the base, the plurality of retractable cable mechanisms coupled with the plurality of ring sizing devices and configured to retain the plurality of ring sizing devices against the plurality of sizing ports when in a retracted configuration, and configured to enable limited movement of the plurality of ring sizing devices relative to the base when in an extended configuration.

In some examples of the apparatus, each sizing port of the plurality of sizing ports comprises an aperture that permits passage of a retractable cable mechanism of the plurality of retractable cable mechanisms through the base.

In some examples of the apparatus, each sizing port of the plurality of sizing ports comprises a first magnet of the plurality of magnets to a first side of the respective aperture, and a second magnet of the plurality of magnets to a second side of the respective aperture.

In some examples of the apparatus, the one or more magnets of each respective ring sizing device comprises a third magnet configured to engage the first magnet of the respective sizing port, and a fourth magnet configured to engage the second magnet of the respective sizing port.

In some examples of the apparatus, the first magnet may be associated with a first polarity and the second magnet may be associated with a second polarity.

In some examples of the apparatus, each respective retractable cable mechanism may be configured to exert a rotational force in a first direction in response to a rotational force applied on the respective ring sizing device in order to orient the respective ring sizing device in the same direction.

In some examples of the apparatus, the plurality of magnets, the plurality of retractable cable mechanisms, or both, may be configured to maintain the plurality of ring sizing devices in a vertical orientation on or within the plurality of sizing ports and the vertical orientation may be substantially normal to a surface of the base.

In some examples of the apparatus, the base comprises a stopping mechanism that may be configured to maintain at least one retractable cable mechanism of the plurality of retractable cable mechanisms in an extended configuration.

In some examples of the apparatus, each ring sizing device of the plurality of ring sizing devices comprises a ring-shaped housing, the ring-shaped housing comprising a first housing component and a second housing component, wherein the second housing component may be configured to move relative to the first housing component to transition the ring-shaped housing between the closed configuration and the open configuration, wherein the ring sizing device may be associated with a fixed ring size when in the closed configuration and a hinging assembly configured to couple a first end of the first housing component with a first end of the second housing component, wherein the hinging assembly may be configured to enable the second housing component to move relative to the first housing component to transition the ring-shaped housing between the closed configuration and the open configuration, wherein the closed configuration may be associated with an inner circumference of the plurality of inner circumferences that corresponds to the fixed ring size, and wherein the open configuration may be associated with a discontinuity between a second end of the first housing component and a second end of the second housing component.

In some examples of the apparatus, the locking assembly further comprises a first locking component coupled to or positioned at least partially within the first housing component, a second locking component coupled to or positioned at least partially within the second housing component and configured to couple with the first locking component when the ring sizing device may be in the closed configuration, wherein the first locking component and the second locking component may be configured to, maintain a coupling between the first locking component and the second locking component when the force exerted on the ring-shaped housing may be less than the threshold, wherein retaining the ring-shaped housing in the closed configuration may be based at least in part on maintaining the coupling, and disengage the coupling to create the discontinuity between the first locking component and the second locking component when the force exceeds the threshold, wherein transitioning the ring-shaped housing from the closed configuration to the open configuration may be based at least in part on disengaging the coupling to create the discontinuity.

In some examples of the apparatus, the first locking component and the second locking component comprise magnetic locking components and coupling the first locking component and the second locking component may be based at least in part on magnetically coupling the first locking component and the second locking component.

In some examples of the apparatus, the first locking component and the second locking component comprise mechanical locking components and coupling the first locking component and the second locking component may be based at least in part on mechanically engaging the first locking component and the second locking component.

In some examples of the apparatus, the first locking component of the first housing component comprises a tab, the second locking component of the second housing component comprises a detent disposed within a recess, and the tab comprises a width that substantially conforms to a second width of the recess.

In some examples of the apparatus, the locking assembly further comprises a release component coupled to or positioned at least partially within the first housing component, the second housing component, or both, wherein the release component may be configured to disengage the first locking component and the second locking component to transition the ring-shaped housing from the closed configuration to the open configuration based at least in part on a second force exerted on the release component.

In some examples of the apparatus, the hinging assembly comprises one or more spring components configured to return the ring-shaped housing from the open configuration to the closed configuration when the force may be removed.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable ROM (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. A ring sizing assembly, comprising:
a plurality of ring sizing devices each configured to transition between an open configuration and a closed configuration, wherein the plurality of ring sizing correspond to a plurality of ring sizes when the plurality of ring sizing devices are in the closed configuration, wherein each respective ring sizing device of the plurality of ring sizing devices comprises:
a locking assembly that is configured to maintain the respective ring sizing device in the closed configuration when a force exerted on the respective ring sizing device is less than a threshold, and transition the respective ring sizing device from the closed configuration to the open configuration when the force exceeds the threshold; and
one or more magnets; and
a base, comprising:
a plurality of sizing ports configured to receive the plurality of ring sizing devices;
a plurality of magnets corresponding the plurality of sizing ports, the plurality of magnets configured to engage the one or more magnets of each of the plurality of ring sizing devices to retain the plurality of ring sizing devices on or within the plurality of sizing ports and to orient each of the plurality of ring sizing devices in a same direction; and
a plurality of retractable cable mechanisms disposed within the base, the plurality of retractable cable mechanisms coupled with the plurality of ring sizing devices and configured to retain the plurality of ring sizing devices against the plurality of sizing ports when in a retracted configuration, and configured to enable limited movement of the plurality of ring sizing devices relative to the base when in an extended configuration.

2. The ring sizing assembly of claim 1, wherein each sizing port of the plurality of sizing ports comprises an aperture that permits passage of a retractable cable mechanism of the plurality of retractable cable mechanisms through the base.

3. The ring sizing assembly of claim 2, wherein each sizing port of the plurality of sizing ports comprises a first magnet of the plurality of magnets to a first side of the respective aperture, and a second magnet of the plurality of magnets to a second side of the respective aperture.

4. The ring sizing assembly of claim 3, wherein the one or more magnets of each respective ring sizing device comprises a third magnet configured to engage the first magnet of the respective sizing port, and a fourth magnet configured to engage the second magnet of the respective sizing port.

5. The ring sizing assembly of claim 3, wherein the first magnet is associated with a first polarity, and wherein the second magnet is associated with a second polarity.

6. The ring sizing assembly of claim 1, wherein each respective retractable cable mechanism is configured to exert a first rotational force in a first direction in response to a second rotational force applied on the respective ring sizing device in order to orient the respective ring sizing device in the same direction.

7. The ring sizing assembly of claim 1, wherein the plurality of magnets, the plurality of retractable cable mechanisms, or both, are configured to maintain the plurality of ring sizing devices in a vertical orientation on or within the plurality of sizing ports, wherein the vertical orientation is perpendicular to a surface of the base.

8. The ring sizing assembly of claim 1, wherein the base comprises a stopping mechanism that is configured to maintain at least one retractable cable mechanism of the plurality of retractable cable mechanisms in the extended configuration.

9. The ring sizing assembly of claim 1, wherein each ring sizing device of the plurality of ring sizing devices comprises:
a ring-shaped housing, the ring-shaped housing comprising a first housing component and a second housing component, wherein the second housing component is configured to move relative to the first housing component to transition the ring-shaped housing between the closed configuration and the open configuration, wherein the ring sizing device is associated with a fixed ring size when in the closed configuration; and
a hinging assembly configured to couple a first end of the first housing component with a first end of the second housing component, wherein the hinging assembly is configured to enable the second housing component to move relative to the first housing component to transition the ring-shaped housing between the closed configuration and the open configuration, wherein the closed configuration corresponds to the fixed ring size, and wherein the open configuration is associated with a discontinuity between a second end of the first housing component and a second end of the second housing component.

10. The ring sizing assembly of claim 9, wherein the locking assembly further comprises:
a first locking component coupled to or positioned at least partially within the first housing component; and
a second locking component coupled to or positioned at least partially within the second housing component and configured to couple with the first locking component when the ring sizing device is in the closed configuration, wherein the first locking component and the second locking component are configured to:
maintain a coupling between the first locking component and the second locking component when the force exerted on the ring-shaped housing is less than the threshold, wherein retaining the ring-shaped housing in the closed configuration is based at least in part on maintaining the coupling; and
disengage the coupling to create the discontinuity between the first locking component and the second locking component when the force exceeds the threshold, wherein transitioning the ring-shaped housing from the closed configuration to the open configuration is based at least in part on disengaging the coupling to create the discontinuity.

11. The ring sizing assembly of claim 10, wherein the first locking component and the second locking component comprise magnetic locking components, and wherein coupling the first locking component and the second locking component is based at least in part on magnetically coupling the first locking component and the second locking component.

12. The ring sizing assembly of claim 10, wherein the first locking component and the second locking component comprise mechanical locking components, and wherein coupling the first locking component and the second locking component is based at least in part on mechanically engaging the first locking component and the second locking component.

13. The ring sizing assembly of claim 10, wherein the first locking component of the first housing component comprises a tab, and wherein the second locking component of the second housing component comprises a detent disposed within a recess, wherein the tab comprises a width that substantially conforms to a second width of the recess.

14. The ring sizing assembly of claim 10, wherein the locking assembly further comprises:
a release component coupled to or positioned at least partially within the first housing component, the second housing component, or both, wherein the release component is configured to disengage the first locking component and the second locking component to transition the ring-shaped housing from the closed configuration to the open configuration based at least in part on a second force exerted on the release component.

15. The ring sizing assembly of claim 10, wherein the hinging assembly comprises one or more spring components configured to return the ring-shaped housing from the open configuration to the closed configuration when the force is removed.

16. The ring sizing assembly of claim 1, wherein the plurality of ring sizing devices comprise a plurality of inner circumferences that correspond to the plurality of ring sizes.
